(19) United States
(12) Patent Application Publication
(10) Pub. No.: US 2008/0126958 A1
(43) Pub. Date: May 29, 2008

(54) ADDING GRAPHICAL USER INTERFACE TO DISPLAY

(75) Inventor: Wayne C. Louie, Uxbridge (CA)

Correspondence Address: VEDDER PRICE KAUFMAN & KAMMHOLZ, 222 N. LASALLE STREET, CHICAGO, IL, 60601, US

(73) Assignee: ATI Technologies Inc., Markham (CA)

(21) Appl. No.: 11/469,233

(22) Filed: Aug. 31, 2006

(51) Int. Cl. G06F 15/16

(52) U.S. Cl. 715/764

(57) ABSTRACT

To operate a computer, a first graphical user interface of a server application is displayed in a first display region, which has user interface elements for presenting output from the server application and receiving runtime user input to the server application. A second display region is also provided, in which graphical user interfaces are provided. The second display region has a defined location and may be a sidebar. In response to user interaction with the first graphical user interface, a first user interface element is selected from the first graphical user interface. The first user interface element presents a type of output from the server application or receiving a type of input to the server application. Further, a client application is configured to display a second graphical user interface in the second display region, such that the second graphical user interface includes a second user interface element corresponding to the first user interface element.

### FIELD OF THE INVENTION

The present invention relates to computing, and particularly to methods and devices for adding a graphical user interface to a display region on a computer display.

### BACKGROUND OF THE INVENTION

Graphical user interfaces (GUIs) have become standard software user interfaces. Most end-user applications now interact with a user by way of a GUI, hosted by a GUI operating system, such as Windows, the Mac OS, or the like, directly or by way of an application called a “window manager”, that controls the placement and interaction of GUI windows. GUIs may be arranged in different display regions of a user screen. For example, a conventional window, forming part of, or defining, an application GUI, may appear anywhere on the screen. Such windows may be tiled, or cascaded.

Many operating systems (or window managers) set aside designated regions, to present GUIs that a user wishes to frequently interact with. Sidebars, for example, are used to provide a designated area or region on a computer desktop, for providing instant ready access to GUIs displayed in the sidebar, without cluttering the work space on the desktop. Sidebars are usually positioned to the side of the desktop, but may be positioned or moved elsewhere.

For example, the Windows Vista™ operating system provides a component known as Windows Sidebar™. The Windows Sidebar is a pane on the side of the Windows Vista desktop that organizes interfaces to smaller applications referred to as “Gadgets” and makes these interfaces easy to access. Gadgets generally are described in Microsoft Sidebar for Windows Vista Beta 2 Gadget Development Overview, Microsoft Windows White Paper, Brian Teutsch, Published on May 22, 2006, the contents of which are hereby incorporated herein by reference.

Generally, gadgets are “mini-applications” that include a graphical user interface that presents information and allows user interaction in a pre-defined region of the display, referred to as a sidebar. Conveniently, underlying gadget program logic and associated gadget may be programmed using a scripting language, such as HTML, and may make a variety of application program interface (API) calls in order to interact with the operating system, and other applications. Gadgets are managed by a sidebar application, that controls their execution. Gadgets may be used for a wide variety of possible purposes. For example, a gadget interface may present a clock, a control panel, a news-feeder, a tickler, or the like. During use, a user may select the gadget application(s) whose interface(s) is or are to be displayed in the Sidebar from a list of available gadget applications provided by the Sidebar. The selection is made through a dialog window called the Gadget Dialog.

Conventionally, the gadgets for displaying the gadget interfaces need to be pre-installed, either in the Vista operating system or in a designated directory. For example, to make an additional gadget available for selection, code for the corresponding gadget has to be stored in the designated directory, which the Sidebar application will search when creating the list of available gadget applications. Typically, unless a gadget's name appears in the list, its interface cannot be displayed in the Sidebar.

A somewhat similar application is provided by the Mac OS X, and is referred to as the Dashboard™. The Dashboard is detailed in Beginning Mac OS X Tiger Dashboard Widget Development, Fred Terry, July 2006, Wrox, the contents of which are also incorporated herein by reference.

However, the conventional software and method of configuring such a user interface presented by mini-application in a designated region of the display, and adding interface elements thereto have some drawbacks. For instance, the conventional Sidebar application is not convenient to use in some aspects. Specifically, the user can only display user interfaces of gadgets selected from the gadget list. However, the user may not know the name of the gadget he or she wishes to display; may not know what the associated user interface looks like before it is displayed; and may not know which gadget to display for a certain purpose.

The gadgets available for user selection are also limited and it is difficult or cumbersome for an average user to add a new gadget application that the user wishes to have. Further, the average user typically cannot flexibly modify the user interface of a gadget as desired, to add or delete elements from the interface.

Accordingly, there is a need for improved methods and devices in which user interfaces, such as those presented by gadgets, can be conveniently added to a designated display region.

### SUMMARY OF THE INVENTION

In a first aspect of the present invention there is provided a method of operating a computer. A first graphical user interface of a server application is displayed in a first display region, which has user interface elements for presenting output from the server application and receiving runtime user input to the server application. A second display region is provided in which graphical user interfaces are presented. The second display region has a defined location. In response to user interaction with the first graphical user interface, a first user interface element is selected from the first graphical user interface. The first user interface element presents a type of output from the server application or receiving a type of input to the server application. Further, a client application is configured to display a second graphical user interface in the second display region, such that it includes a second user interface element for presenting the type of output from the server application or receiving the type of input to the server application. Each of the first and second user interface elements may both present the type of output and receive the type of input. The second display region may be a sidebar region and presentation of graphical user interfaces in the sidebar region may be controlled by a manager application such as a sidebar application. User interaction with the first graphical user interface may comprise selection of the first user interface element, effected by a user placing a pointer on the first user interface element. User interaction with the first graphical user interface may be effected by a user opening a menu associated with the first graphical user interface, and selecting a menu item from the menu for sending or exporting the first user interface element to the second display region. User interaction with the first graphical user interface may be effected by a user dragging-and-dropping the first interface element into the second display region, or by a user dragging-and-dropping an existing user interface in the second display region onto the first user interface element. A user interface configuration application for configuring the client application may be provided, which may create a script file for configuring the client application, and cause the script file to be executed so as to display the second user interface in the second display region. Descriptor data describing the type of output or input may be communicated to at least one of the client application or the user interface configuration application. The descriptor data may be communicated from the server application or a system server. Any communication may be through inter-process communication (IPC). The inter-process communication may be compliant with one or more of common object request broker architecture (CORBA), distributed computing environment (DCE), Java Remote Method Invocation (Java RMI), object linking and embedding (OLE), component object model (COM), distributed component object model (DCOM), Windows .Net framework, Internet Information Services (IIS), and Windows communication foundation (WCF) framework. The communicated data may be compliant with one or more of a hyper text transfer protocol (HTTP), an extended mark-up language (XML), an XML schema definition (XSD), a web service definition language (WDSL), and a Java programming language. At least one of the type of input and the type of output may comprise one or more of data types selected from numerical ranges, character strings, integer ranges, named item sets, Boolean sets, read-only data, and binary status indicators. At least one of the first and second user interface elements may comprise one or more of buttons, boxes, bars, menus, data entry fields, lists, graphs, and tickers for presenting the type of output or receiving the type of input.

In accordance with another aspect of the present invention, there is provided a method of operating a computer. The method comprises, in response to user interaction with a first graphical user interface for communication with a server application, the first graphical user interface displayed in a first display region and comprising a plurality of user interface elements for presenting output from the server application and receiving runtime user input to the server application, the user interaction causing a first user interface element being selected from the first graphical user interface, the first user interface element presenting a type of output from the server application or receiving a type of input to the server application, displaying a second graphical user interface, in a second display region having a defined location, such that the second graphical user interface comprises a second user interface element for presenting the type of output from the server application or receiving the type of input to the server application.

In another aspect of the present invention, there is provided a computer comprising a display, a processor and a computer readable medium storing thereon computer executable code. The computer executable code when executed on the processor causes the processor to perform one or more of the methods described above.

In a further aspect of the present invention, there is provided a computer readable medium storing thereon computer executable code, the computer executable code when executed on a computer causing a processor of the computer to perform one or more of the methods described above.

Other aspects and features of the present invention will become apparent to those of ordinary skill in the art upon review of the following description of specific embodiments of the invention in conjunction with the accompanying figures and tables.

### BRIEF DESCRIPTION OF THE DRAWINGS

In the figures, which illustrate, by way of example only, embodiments of the present invention,

FIG. 1 is a schematic view of a computer system having a display;

FIG. 2 is a schematic view of the display of FIG. 1 during use;

FIG. 3 is a block diagram showing the inter-relations among various components related to displaying user interfaces in a sidebar;

FIG. 4 is flowchart for a method of providing a user interface in the sidebar of the display of FIG. 2;

FIG. 5 is an exemplary screenshot of the display of FIG. 1 during use;

FIG. 6 is another exemplary screenshot of the display of FIG. 1 during use; and

FIG. 7 is further exemplary screenshot of the display of FIG. 1 during use.

### DETAILED DESCRIPTION

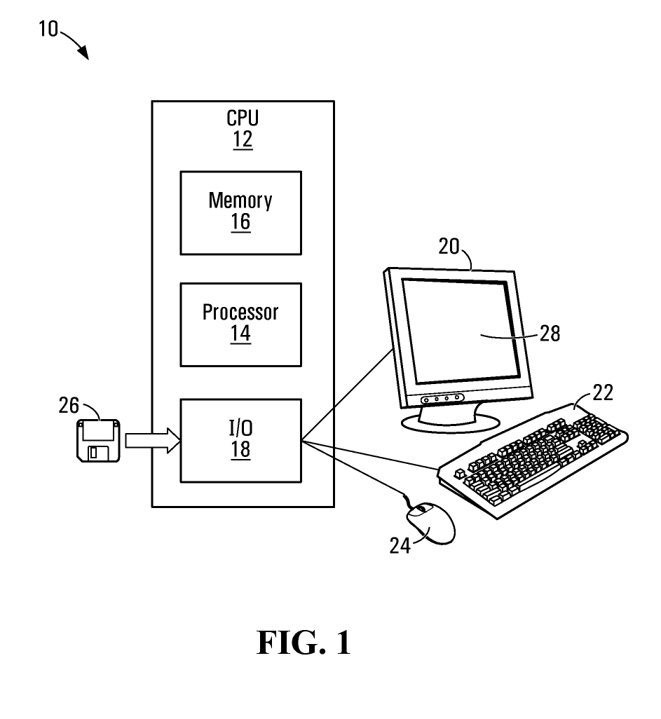

FIG. 1 illustrates computer 10, exemplary of an embodiment of the present invention.

Computer 10 includes a central processing unit 12, which includes a processor 14, in communication with a memory 16 and input/output (I/O) 18. Computer 10 may optionally communicate with a network (not shown) or another device (not shown). Computer 10 has a display device, such as monitor 20, in communication with I/O 18. Computer 10 may also have one or more input devices such as keyboard 22 and mouse 24, in communication with I/O 18. A removable memory storage medium such as disk 26 may be provided and is accessible through I/O 18 by the CPU 12. As illustrated, a desktop window 28 may be displayed on monitor 20.

Processor 14 can be any suitable processor including microprocessors, as can be understood by persons skilled in the art. Processor 14 may include one or more processors for processing data and computer executable codes or instructions.

Memory 16 may include a primary memory readily accessible by processor 14 at runtime. The primary memory may typically include a random access memory (RAM) and may only need to store data at runtime. Memory 16 may also include a secondary memory, which may be a persistent storage memory for storing data permanently, typically in the form of electronic files. The secondary memory may also be used for other purposes known to persons skilled in the art. Memory 16 can include one or more computer readable media. For example, memory 16 may be an electronic storage including a computer readable medium for storing electronic data including computer executable codes. The computer readable medium can be any suitable medium accessible by a computer, as can be understood by a person skilled in the art. A computer readable medium may be either removable or non-removable, either volatile or non-volatile, including any magnetic storage, optical storage, or solid state storage devices, or any other medium which can embody the desired data including computer executable instructions and can be accessed, either locally or remotely, by a computer or computing device. Any combination of the above is also included in the scope of computer readable medium. Disk 26 may form a part of memory 16. Memory 16 may store computer executable instructions for operating computer 10 in the form of program code, as will be further described below. Memory 16 may also store data such as operational data, image data, input data, and output data.

I/O 18 may include any suitable combination of input and output devices. I/O 18 may be integrated or provided on separated components, and may be in communication with any number of input and output devices. The input devices may include a device for receiving user input such as user command or for receiving data. Example user input devices may include a keyboard, a mouse, a disk drive/disk, a network communication device, a microphone, a scanner, a camera, and the like. Input devices may also include sensors, detectors, or imaging devices. The output devices may include a display device such as a monitor for displaying output data to a user, a printer for printing output data, a communication device for communicating output data to another computer or device, and the like, as can be understood by persons skilled in the art. The output devices may also include other devices such as a computer writable medium and the device for writing to the medium. An input or output device can be locally or remotely connected to CPU 12, either physically or in terms of communication connection.

It will be understood by those of ordinary skill in the art that computer 10 may also include other, either necessary or optional, components not shown in the FIG. 1.

The hardware in computer system 10 may be manufactured and configured in any suitable manner, as will be understood by one skilled in the art.

Memory 16 or disk 26 may store thereon computer executable code, including instructions which, when executed by processor 12, can cause computer 10 to perform as described below. Suitable software incorporating the code may be readily developed and implemented by persons skilled in the art, in manners that will become apparent.

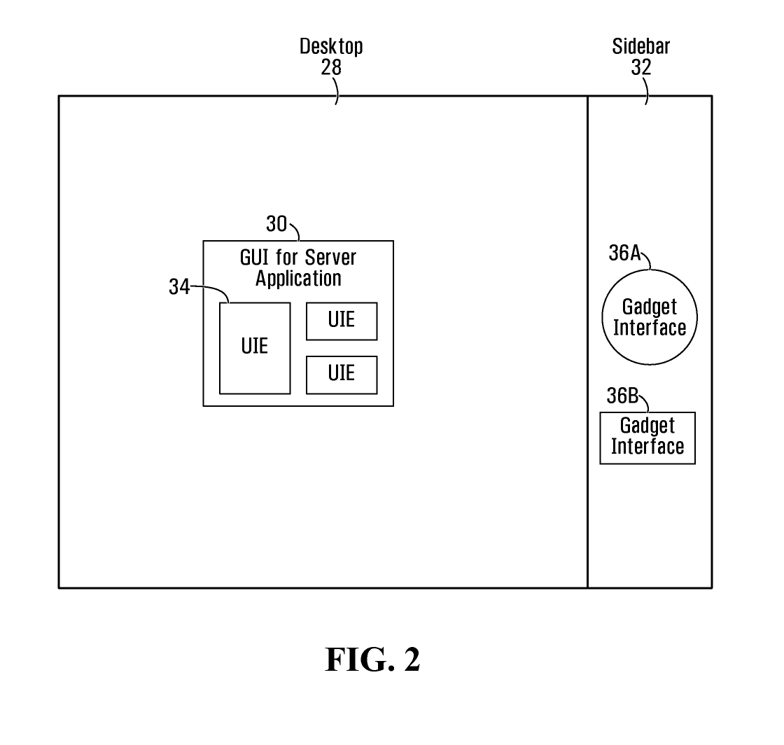

A method of operating computer 10, exemplary of an embodiment of the present invention, is described next with reference to FIGS. 2 to 7.

FIG. 2 is an exemplary screen shot of the desktop 28. As can be seen, desktop 10 includes a graphical user interface (GUI) 30 and a designated display region 32.

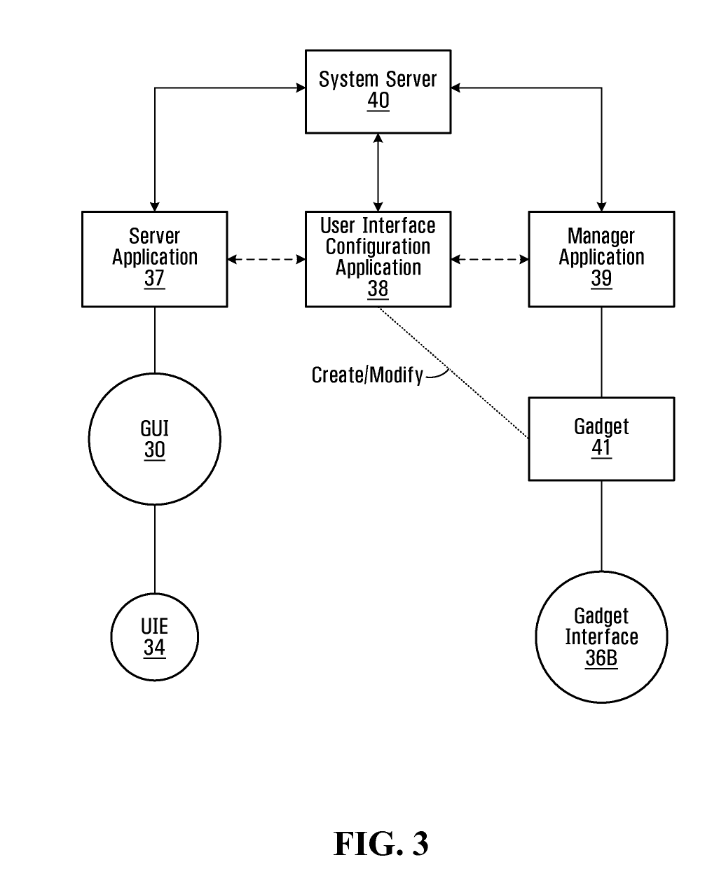

GUI 30 is displayed in a display region different from the designated display region 32 and includes a number of user interface elements (UIE) such as UIE 34 for providing an interface between a user (not shown) and a server application 37 (not shown but see FIG. 3). The UIEs may present output from server application 37 and receive user input, particularly runtime user input, to server application 37.

In the depicted embodiment, display region 32 is managed by a manager application 39 (not shown but see FIG. 3). In the depicted embodiment, manager application 39 may be the Windows Vista Sidebar application. In other embodiments, manager application 39 may be formed as the Dashboard manager of the Mac OS X.

As can be understood, GUI 30 may be selectively displayed and may include one or more conventional UIEs, such as widgets or UI controls. Each UIE may hold data and present an interface of the associated end-user application. A UIE may refer to any graphical component in a graphical user interface (GUI) and may be associated with one of both of input and output semantics.

GUI 30 may be created using object oriented programming technique. UIEs may be defined by objects (UIE objects) that are children of an object defining GUI 30. Objects may hold both code and data, and may provide an input or an output object, or both. For example, a UIE may be presented in the form of a window or sub-window with a particular appearance and behaviour. Each UIE may contain one or more UI controls, enabling user interaction or input, such as to initiate an action, display information, or set values. A control may be a graphic object that represents operations or properties of another object, application or process. For example, a UIE object may include a window, a graphical element or a collection of graphical elements such as buttons including radio buttons, pushbuttons and the like, bars including slider bars, menu bars, title bars, scroll bars and the like, boxes including text boxes, check boxes, combo boxes, spin boxes and the like, lists including drop-down lists, scrolling lists and the like, menus including popup menus, dropdown menus, cascade menus and the like, tickers, data entry fields, or any and all other paraphernalia that a window can have or contain.

A UIE object may belong to an object class and may implement procedures through its class structure. A UIE object may provide a combination of state(s) and procedure(s). Each UIE may be a member of a class, which holds the procedures and data structures common to all UIEs of that class. An instance of the class may hold the procedures and data structures particular to that single instance. Each UIE class may provide the general behaviour associated with a particular kind of interaction with the user, such as input or output behaviour. UIEs such as widgets and controls are commonly used in computing and can be readily constructed by those skilled in the art. The different UIEs forming GUI 30 may be displayed at the same time or at different times, depending on the particular application and user selection or preference.

One or more graphical user interfaces, such as gadget interfaces 36A and 36B (also individually and collectively referred to as gadget interface or interfaces 36), are specifically presented in designated display region 32. Designated display region 32 typically has a pre-defined location on one desktop (or on an extended desktop), such as on the side of a display screen, as shown. In a different embodiment, region 32 may be replaced with any designated display region or area wherein one or more graphical user interfaces are only displayed on the occurrence of certain events. For example, the MacOS X Dashboard similarly presents graphical user interfaces, on an overlay that occupies the entire screen upon user interaction with an icon.

Region 32 may be positioned on the side of a display as shown or at another convenient location. Region 32 may be positioned to avoid cluttering the work space in desktop window 28. Region 32 may also be positioned to avoid blocking other application windows displayed in desktop window 28. As can be appreciated, Region 32 may have various sizes, shapes, or locations. Region 32 may be resizable or re-locatable. In some embodiments, region 32 or any user interface displayed therein may be selectively hidden from view or activated at user's choice. Region 32 may be expandable such as when a user clicks on a particular gadget interface to have an expanded view of the gadget interface.

A user interface 36 such as gadget interface 36B may provide instant access by a user. While only two user interfaces are displayed in region 32, it should be understood that a different number of gadget interfaces may be displayed. A gadget interface may include one or more UIEs, as can be understood by a person skilled in the art. For example, a gadget interface 36B may display a clock, a control panel, a news-feeder, a ticker, an email viewer, or the like. The exact format of the gadget interface may be defined using HTML or a similar scripting language as detailed in Microsoft Sidebar for Windows Vista Beta 2 Gadget Development Overview, supra. A displayed gadget interface may be associated with an underlying script or program object which performs certain computing functions.

In the depicted embodiment, user interfaces 36 are graphical interfaces of gadgets. However, in other embodiments, user interfaces 36 could be GUIs for other applications or components of applications which a user may wish to have ready access during use.

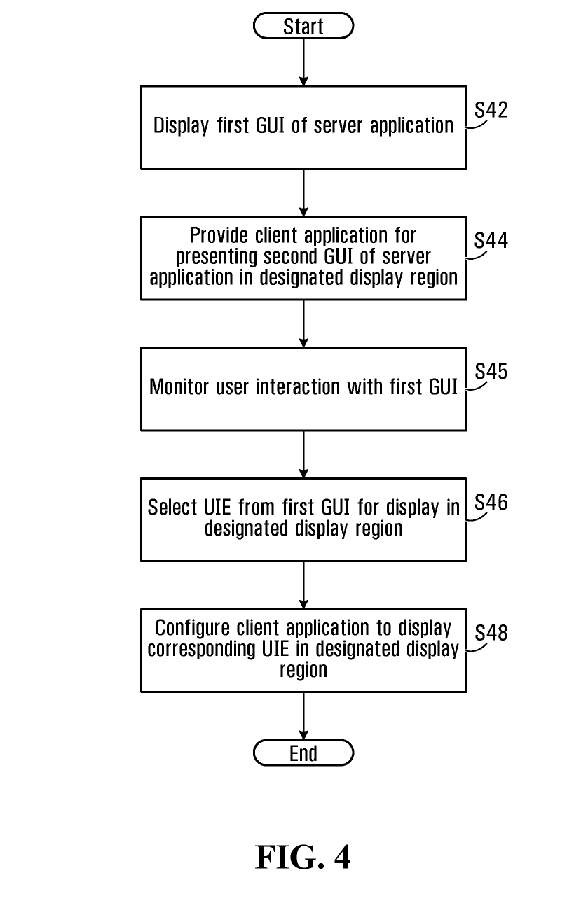

Conventionally, a gadget interface 36 is added by adding a gadget for management by manager application 39. In manners exemplary of embodiments of the present invention, a user interface 36, such as gadget interface 36B, may be added at runtime as described and illustrated with reference to FIGS. 3 and 4.

FIG. 3 schematically illustrates the various computer applications that may be involved in an exemplary process of adding a graphical user interface in a designated display region 32, and their interrelations with each other and with the displayed objects shown in FIG. 2. The applications include server application 37, user interface configuration application 38, manager application 39, an optional system server 40, and a gadget (or gadgets) 41.

As illustrated, a UIE 34 is associated with GUI 30 of server application 37 for interfacing server application 37 with a user. Server application 37 may be any suitable application executing on computer 10.

In the depicted embodiment, server application 37 and gadget 41 have a server-client relationship with each other, in that data from server application 37 is provided to gadget 41, and interaction with the gadget interface of gadget 41 may provide data to server application 37. Thus, gadget 41 may be considered a client application with respect to server application 37. For example, server application 37 may be the Catalyst Control Center (CCC) developed by ATI™ Technologies Inc., and gadget 41 may a gadget designed to provide a user interface for the CCC.

GUI 30 includes UIE 34 may be an interface for any component, part, feature or aspect of server application 37.

User interface configuration application 38 may communicate with one or both of system server 40 and server application 37. User interface configuration application 38 may take the form of an application suitable for creating or configuring user interfaces such as gadgets, exemplary of an embodiment of the present invention. In one embodiment, user interface configuration application 38 may be executing in the background. User interface configuration application 38 may communicate directly or indirectly with server application 37 and manager application 39. User interface configuration application 38 may also communicate with system server 40. User interface configuration application 38 may listen for requests of adding user interfaces to desktop 28, and more particularly to region 32, for example, originating with server application 37. On requests from server application 37, system server 40, or another application, user interface configuration application 38 may dynamically configure a client application, such as a gadget, and cause the display of additional or modified UIEs, that may be added to region 32, as will be further described below.

Manager application 39 manages the presentation of user interfaces in region 32. Manager application 39 may be in communication with user interface configuration application 38 and system server 40. Exemplary manager application 39 may take the form of the Windows Sidebar, the Google™ Desktop Sidebar, the Mac OS X Dashboard application, or the like. In the literature and herein, the term “sidebar” is sometimes used to refer to one or both of the physical display area and the underlying application or the associated program code, depending on the context. Manager application 39 may present the list of available gadgets that may be presented for user selection, and the associated gadget interface may be displayed.

System server 40 provides inter process/application communication to applications running on computer 10. For example, system server 40 may serve as a data server. In one embodiment, system server 40 may include a Catalyst Control Center Runtime data server (CCC Runtime). The CCC runtime may be compliant with the .Net framework or another suitable communication framework such as Internet Information Services (IIS). System server 40 may communicate with one or more of applications 37, 38, and 39 and gadget 41.

Communication between the applications operating on computer 10 may be provided according to any suitable inter-process communication (IPC) protocol by way of suitable API. For example, the Microsoft .Net remoting API may be used under the .Net framework to facilitate communication between different applications. .NET Remoting is an enabler for application communication. It is a generic system for different applications to use to communicate with one another. .NET objects are exposed to remote processes, thus allowing inter-process communication. The applications can be located on the same computer, different computers on the same network, or even computers across separate networks. As can be understood, with a .Net Remoting API, and the assistance of an operating system and network agents, a client process can send a message to server 40 and receive a reply. Thus, two separate client processes may communicate with each other through the server 40, using the .Net Remoting technique.

Other IPC APIs, standards, architectures, or frameworks may also be used for communication between different applications or processes, which include Object Linking and Embedding (OLE), Component Object Model (COM), Distributed Component Object Model (DCOM), Active X, Windows Communication Foundation (WCF), Common Object Request Broker Architecture (CORBA), Distributed Computing Environment (DCE), Java Remote Method Invocation (Java RMI), IIS, and the like.

Communication, such as data communication, queries and function calls between different applications domains/servers, may be implemented in any suitable manner. For instance, the Hyper Text Transfer Protocol (HTTP) may be used. Other functionalities and techniques may also be implemented. For example, one or more of the Object Linking and Embedding (OLE) functionalities, Component Object Model (COM) servers, Extended Mark-up Language (XML) and XML Schema Definition (XSD) functionalities, and Web Service Definition Language (WDSL) functionalities may be provided.

For the purpose of illustration, the following is assumed in the exemplary embodiment illustrated in FIGS. 3 and 4. Computer 10 operates in the following environment (but it should be understood that in a different embodiment, computer 10 may operate in a different operating environment). The operating system of computer 10 is the Windows Vista operating system. Server application 37 is the Catalyst Control Center (CCC). A generic object class, Gadget class, is provided for forming user interface objects which provide user interfaces for server application 37 in region 32. User interface configuration application 38 is capable of creating gadgets, such as instantiating a Gadget object based on the Gadget class, or modifying an existing Gadget object. Manager application 39 is a sidebar application such as Windows Vista Sidebar. No gadget files associated GUI 30 or UIE 34 are stored in the designated gadget file directory monitored by the sidebar application. System server 40 includes the CCC runtime server, the .Net framework and Remoting API deployed on computer 10 to provide a framework and tools for communication between different applications.

A Gadget object may be a remotable type of object, as can be understood by persons skilled in the art. For example, under .Net framework and .Net remoting, a remotable object is an object that inherits from a class defined under the .Net framework, named MarshalByRefObject. A remotable object may be exposed. For example, a server object may be provided to act as a listener to accept remote object requests. In the present example, system server 40 acts as a .Net remoting host that monitors (listens for) requests for Gadget objects. Server application 37 may communicate with system server 40, such as through a HTTP communication channel. As can be appreciated, another application or process in communication with system server 40 can request system server 40 to create an instance of the remotable object. The .Net Remoting technique is described, e.g. in Pro .NET 1.1 Remoting, Reflection, and Threading, David Curran et al., 2005, Apress Publisher, the contents of which are incorporated herein by reference.

User interface configuration application 38 can cause an instance of a Gadget object to be instantiated or modified. For example, user interface configuration application 38 may be able to create the necessary file or files for creating a gadget 41 in sidebar region 32 under the control of manager application 39. The created file(s) may be stored in a designated directory associated with manager application 39. Once the files are created, user interface configuration application 38 may communicate, directly or indirectly, with manager application 39 to cause the newly created gadget file(s) to be executed. When the file(s) is(are) executed, gadget 41 is deployed or instantiated. Once gadget 41 is running, it can present gadget interface 36b in region 32, which acts as a user interface to application 37. User interface configuration application 38 may alternatively modify an existing gadget file to modify the appearance or behavior of the associated gadget interface. In a different embodiment, the required gadget files or template gadget files may be preexisting and stored at a location known to user interface configuration application 38, which is able to modify and move the files to the designated sidebar directory.

In one embodiment, the gadget file may include a gadget file and any associated files that are used by Windows Vista Sidebar to display gadget interfaces. The file may be an html script file. A template file may be modified based on the selected UIE 34 to create the specific gadget file and any associated files. The data needed to create the files may be obtained as described herein or in another suitable manner as can be understood by persons skilled in the art. A copy of the gadget file may be placed in the file directory designated for storing Sidebar gadget files. To invoke the gadget, a request may be sent to manager application 39 to load the .gadget file into memory for execution by processor 14.

In an exemplary process, as illustrated in FIG. 4, GUI 30 is initially displayed (at S42). User interface configuration application 38 is provided and executed on computer 10 (at S44). User interaction with GUI 30 is monitored by server application 37 (at S45). On receiving a user request to add a gadget interface corresponding to a UIE of GUI 30, such as UIE 34, to region 32 (at S46), a request for adding a gadget may be communicated to user interface configuration application 38, which then configure a gadget application, such as by creating or modifying gadget 41, to display gadget interface 36B in region 32 with a UIE corresponding to UIE 34 (at S48). For instance, the configuration of gadget 41 may be by way of instantiating a new instance of gadget 41, which in turn presents a new instance of a gadget interface object, gadget interface 36B. The new gadget object of Gadget 41 may be instantiated based on the Gadget class but populated with input data specifically associated with UIE 34, as will be further described below. In different embodiments, a UI control in an existing gadget interface 36B may also be modified in response to user request. A new UI control may be added to an existing gadget interface 36B in response to user interaction with GUI 30.

As can be appreciated, under the assumptions described above, user requests to display (add) UIEs to region 32 can be monitored by any monitoring application (at S45). The user request may be effected by way of user interaction with GUI 30. In one embodiment, server application 37 may be the monitoring application. In a different application, system server 40 or user interface configuration application 38 may be the monitoring application. More than one application may simultaneously monitor the user interaction with server application 37. For example, in different embodiments, either or both of the CCC and the CCC runtime server may monitor the user requests.

The selection of a particular UIE and the request to add a corresponding user interface in region 32 may be effected in a number of manners. For example, it can be effected through GUI 30 with a user input device such as mouse 24 or keyboard 22. The selection of a UIE or an application may be effected when the UIE or application is activated, or brought to the foreground (i.e. brought into “focus”). For instance, a user may effect the selection of a UIE by placing a mouse pointer on the UIE and right clicking the mouse to bring the UIE in focus. This interaction may generate a call back to the monitoring application, which may recognize the special interaction as signaling a desire to add a user interface corresponding to the UIE to region 32.

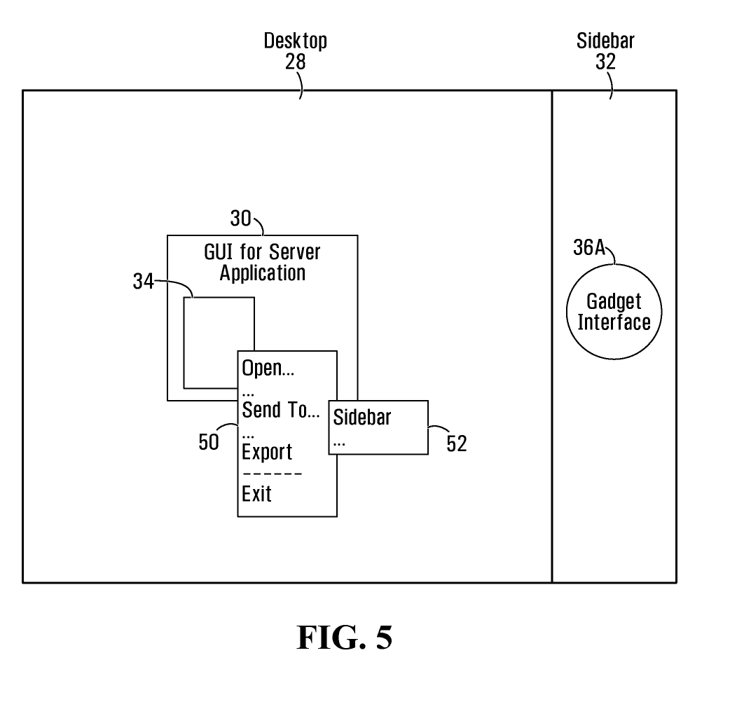

In different embodiments, the selection and request may further include user options, presented by way of pull-down menus, a pop-up menu, dialog boxes, or the like, generated under control of the monitoring application. The menu/dialog box may be context-sensitive. For example, as illustrated in FIG. 5, a pop-up menu 50 may be activated within the window of UIE 34. As shown, menu 50 may list a number of items for the user to choose, one of which may be “Send to . . . ”. The user may click on the “Send to” item, which may open a sub-menu 52. Sub-menu 52 may list, among other options, “Sidebar”. The user can complete the selection/request by clicking on the “Sidebar” item. As can be appreciated, a user may send multiple items to region 32 and multiple gadget interfaces respectively associated with the selected items may be displayed in region 32.

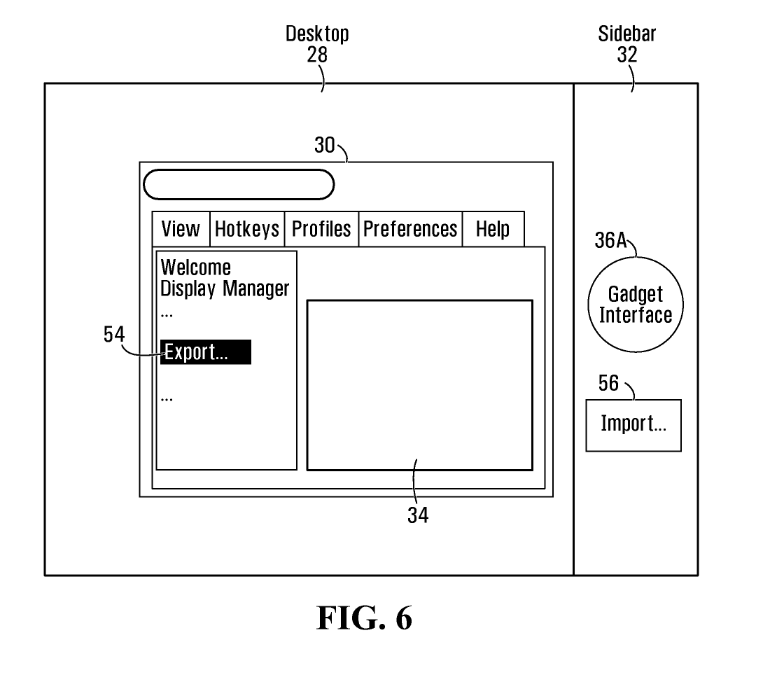

An alternative mechanism is to use an “Export/Import” mechanism to effect the request to add a UIE to a gadget interface. In one exemplary embodiment, as shown in FIG. 6, an “Export” option, such as a menu item 54, may be made available on the Dashboard of CCC. The Dashboard may have pre-designated specific Group Boxes as exportable items, and may allow the user to select specific Group Boxes to be exported. The selection may be implicitly made. For example, a selected Group Box may be the UI control that is active (in focus) while the Dashboard is the active window (in focus). As can be appreciated, multiple items or UIEs may be exported.

In another embodiment, after a graphical user interface, such as the gadget interface 56, for the newly created gadget 41 is displayed, further user input may be received through gadget interface 56, as illustrated in FIG. 6. For example, a Form window may be opened for the user to fill in certain information. A menu may be provided in gadget interface 56 for the user to make further selection. Alternatively, the selected UIE 34 may be imported into gadget interface 56. An “Import” option may be made available on gadget interface 56, as shown, to allow the user to choose the “Import” function. In response to the user's selection of the “Import” function, gadget 41 may query the Dashboard or the CCC runtime, such as through the .NET remoting interface, and obtain a list of item names that are importable into the Gadget object. The list is shown to the user for further selection. The list may be customized for an already selected Group Box (such as the one in focus), or may contain all importable items from the Dashboard. The list may be hierarchically structured to assist the user to select the item(s) to be imported.

As can be appreciated, one or both of the Import and Export functionalities may be provided in any given embodiment. Further, user interface configuration application 38 may present a different user interface for obtaining further user input.

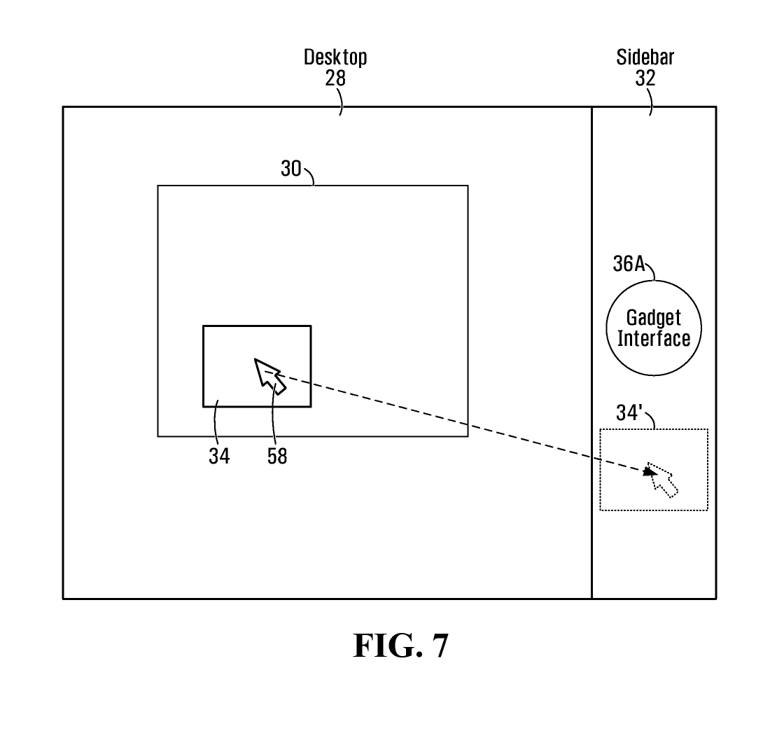

In an alternative embodiment, the selection/request may be made by a drag-and-drop technique, as can be understood by one skilled in the art. As illustrated in FIG. 7, a user may use mouse 24 (not shown) to select UIE 34 by placing a mouse pointer 58 on it, and drag-and-drop the selected UIE 34 into region 32, as indicated by the dotted-line and the ghost-line box 34′. As can be appreciated, in a GUI environment, some displayed objects may be drag-and-dropped across different user interfaces, display regions, and display windows. For example, a control panel on the CCC Dashboard may be drag-and-dropped into region 32. The drag-and-drop method may be implemented using the Microsoft OLE protocol, as can be readily understood by one skilled in the art. Alternatively, when a user wishes to modify an existing gadget interface or add a revised gadget interface based on an existing gadget interface for UIE 34, the user may drag the existing gadget interface and drop it onto UIE 34 to effect the selection and request.

When a user makes a request to display or modify a gadget interface in region 32, the user may be asked to select the item(s), such as controls, to be displayed. A list of available items may be fetched from the CCC Runtime and presented to the user. The list may be hierarchical. The user may select from the list one or more items to be displayed in the eventual gadget interface. As can be appreciated, the list may be dependent on the particular UIE 34 selected by the user. A Form window may be opened for the user to fill in the required particulars, display details, user preferences, or other information.

As illustrated in FIGS. 3 and 4, once a user request to add a UIE has been received by the monitoring application, gadget 41 may be created or reconfigured to display the gadget interface including the UIE. The configuration of gadget 41 may be effected by passing the request to user interface configuration application 38, which then make the corresponding gadget file(s) available to manager application 39 for displaying or modifying the corresponding gadget interface in region 32. The gadget files may be created or modified based on the selected UIE 34, as well as on any further selection of items to be displayed if such further selection has been made. In the following description, it is assumed that user interface configuration application 38 will handle the request and make the gadget interface available for display by manager application 39. In alternative embodiments, the request may be passed to, and handled by, a server application 37 itself, or another application such as system server 40. In these latter cases, the following description may be modified accordingly as can be understood by one skilled in the art.

User request may be received as a result of user interaction with GUI 30. When a request is received, user interface configuration application 38 starts collecting information necessary to configure the gadget application such as gadget 41, such as in manners described earlier. In one embodiment, a UIE such as a UI control in the gadget interface may be added, deleted, or modified based on the collected information by instantiating and populating an instance of the Gadget object using this information. A corresponding gadget interface may be displayed in region 32 either before or after all information has been collected.

To make it possible to instantiate different gadget instances from a generic Gadget type, a generic Gadget object may have a plurality of selectively displayable features, which can be selected either by a user or automatically based on the selected UIE 34. In another embodiment, a number of different gadget classes may be provided for instantiating different types or classes of gadgets. For example, different classes of gadget interfaces may have different fields to be filled, depending on the types of data to be displayed in the gadget interface. When different gadget classes are provided, the gadget to be instantiated may be selected from the list of available types based on the particular selected UIE 34, either automatically or based on user input, or a combination of both.

As can be understood, a gadget interface may include display features such as data fields or UI controls. To display these features, certain data need to be obtained or specified. These data may have different data types. Possible data types for a gadget may include numerical values, character strings, Boolean values, binary status indicators, control buttons or slider bars, localized and non-localized read-only texts, and the like. When UIE 34 is selected, the types of data to be displayed can be determined and the data types that would be needed can also be determined. The values for these data types may be obtained automatically, such as by querying the CCC Runtime. Additional input or configuration requirement may be provided by a user. For example, a communication channel may be provided to connect user interface configuration application 38 to the CCC Runtime for fetching data records that describe selected items to be displayed, using the name of the selected item. The data types and value ranges for each item may be determined from the data records. The data describing the display items of the Gadget object can be encoded (formatted) using different techniques. For example, the data may be described using standard XML/XSD technique.

To allow configuration application 38 to create a suitable gadget, specific descriptor data such as descriptor records may be used for defining the ranges of values. For instance, the descriptor records listed in Table I may be used:

TABLE I
Exemplary descriptor records for possible data types (range kinds)
and possible corresponding UI controls

| Data Type | Descriptor | | | Example | UI Control |
|---|---|---|---|---|---|
| Numerical | Minimum | Maximum | type | 1.0, 21.1, linear | slider (with text |
| range | | | | | entry box) |
| Integer range | Minimum | Maximum | step | −10, 10, 2 | spin button |

| | | | |
|---|---|---|---|
| Integer set | Discrete integer values | 1, 3, 6, 7, 99 | combo list box |
| | | | (drop-down list with |
| | | | text entry box) |
| Name set | Names | Red, green, | drop-down list box |
| | | blue | |
| Boolean set | Pairs of Boolean values | on, off; true, | checkmark |
| | | false; up, down | |
| Read-only | Any value(s) that cannot be | | no specific control |
| (non-localized) | localized | | |
| Read-only | Any value(s) that can be | | no specific control |
| (localized) | localized | | |

In different embodiments, some information, such as the UI control description, in Table I may be omitted and additional information may be included.

As can be appreciated, in some applications, more than one UI control can be used to represent the corresponding UIE 34. When different UI controls are available or when gadget 41 needs to know which UI control(s) is(are) to be used for each particular gadget interface, the value ranges and data types described above may be used to determine which UI control is to be used. The UI controls for each data type may also be specified in the data descriptor, such as shown in Table I. Alternatively, the user may select a UI control from a list which is presented for selection based on the type/class of the gadget object or its data type/value range. The UI controls shown in Table I may be used to display the corresponding data types. As can be understood, each data type may always be displayed as a text string in a read-only text field.

As can be appreciated, depending on the application, gadget interface 36B may include a UIE that appears and behaves exactly like UIE 34, or appears or behaves differently. In any case, the UIE is able to present the same type of output from server application 37 or receive the same type of input to server application 37 as UIE 34 does.

When necessary data is communicated to user interface configuration application 37, gadget 41 may be configured and instantiated to display gadget interface 36B in region 32. Gadget interface 36B may be selectively displayed in region 32. As can be appreciated, a gadget interface may be displayed (docked) or not displayed (undocked) in region 32 at the option of the user.

The information or data displayed in gadget interface 36B may need to be communicated to gadget 41. The values for any particular data item (such as data field or UI control) may be obtained once, such as when the data item is initially selected. The values may also be updated, such as on the occurrence of a triggering event, or periodically. For example, when the CCC Runtime detects a change in value of a particular data field, the corresponding value shown in the gadget interface may be updated. Gadget 41 may poll the values from a server periodically, such as through a system service from system server 40.

In different embodiments, gadget 41 may be in communication with the CCC Runtime. Gadget 41 may also be registered with the CCC Runtime so that the CCC Runtime can make a callback to gadget 41. The registration may be effected in any suitable manner understood by one skilled in the art. For example, the call registration may be implemented using the “delegates” supplied through a .NET Remoting connection. The CCC Runtime may call gadget 41 with a set of values to populate the items to be displayed on gadget interface 36B immediately after the initial connection in order to establish the initial values for the UI controls on gadget interface 36B. After initial connection, the CCC Runtime may call gadget 41 whenever the CCC Runtime detects a new value to update the displayed value on gadget interface 36B. In some embodiments, descriptor data such as one or more of those listed in Table I may be communicated to gadget 41, either for modifying gadget interface 36B or for creating a new gadget interface (not shown).

As described above, gadget interface 36B may be updated or modified, either automatically or manually by a user.

As can be appreciated, it is not necessary that the displayed value in a gadget interface always exactly matches the true value or the value registered with the server. For example, there may be a time delay before a value is updated. A displayed value may merely indicate an approximate value, or desired value or a value that is to be reached.

Further, as can be appreciated, some displayed items in a gadget interface 36 may be modified by a user and others items may be non-modifiable by the user, depending on the particular item. When an item in gadget interface 36B is modified by a user, the corresponding value may be communicated to system server 40 so that the corresponding system value can be updated. For example, when a slider bar is moved in the gadget interface, such as to adjust the clock speed, the speaker volume or graphics resolution, the corresponding change in clock speed, speaker volume or graphics resolution may be made by computer 10. Different techniques may be implemented to effect such a change or communication. For example, one or more of the OLE, COM, XML/XSD, and WDSL functionalities and services may be used.

For example, the CCC Runtime may support a generic “put” operation, in which the CCC Runtime receives a value in the “string” format. The CCC Runtime then converts the string into the appropriate data type with a corresponding value (range) and performs the “set” operation with the converted value (range).

In some cases, a user modified value may merely indicate that the new value is potentially desired, which is not immediately applied. In such cases, a separate trigger event may be required to actually cause the value to be applied. For example, an “apply” button may be pressed by the user as a trigger. The user may also select other actions such as cancel, revert, or undo. In other cases, the user entered values may be immediately applied every time the user finishes making a value modification or input.

As can be understood, the names of the data items in the gadget interfaces 36 may be optionally localized, i.e., translated into a local language. The data descriptor records may include indicators indicating whether or not any name should be localized. Alternatively, the names of the data items may be localized whenever it is possible, such as when a corresponding localized value can be found in the localization cache. In some embodiments, only a selected group of data types may be localized. For example, one may only localize Name sets, Boolean sets, and Read-only (localized) data types.

Localization may be achieved in any suitable manner, as can be understood by one skilled in the art.

As now can be appreciated, the exemplary embodiments described herein can be convenient to use. A user may conveniently select any component of an application and display a gadget interface for that component in a designated display region such as a sidebar. The user can determine before the gadget interface is displayed what the gadget interface will look like and how it will behave. The user can determine which gadget interface best suits his or her preference. The user is not limited by the limited choices shown in the list of available gadget interfaces maintained by the sidebar application. In addition, more gadget interfaces may be dynamically added to the list. The user is also not limited by how a gadget interface can be selected for presentation. The user may display a gadget interface from the primary GUI of the server application while using that application.

As now can be understood, the exemplary embodiments described herein can be modified in various manners in different applications. For example, there are many optional and functionally equivalent techniques for communication, for instantiating applications at runtime, for deploying objects or applications across different application domains, servers, or platforms. A person skilled in the art would understand that replacing one technique with another equivalent technique would not materially affect the functionality of the embodiment. For example, while the .Net framework and the remoting technique is used in some of the exemplary embodiments discussed above, other communication framework and techniques may be used instead.

The techniques discussed above are not only applicable for adding gadget interfaces to a sidebar, they may also be applied for providing user interfaces for various applications in other types of display regions.

In alternative embodiments, two or more applications described above may be integrated. The functions of one application described above may also be performed by separate applications.

The applications or computer executable code described herein can be implemented in any suitable programming language, as can be appreciated by one skilled in the art.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of operating a computer, comprising:
displaying in a first display region, a first graphical user interface for communication with a server application, and comprising a plurality of user interface elements for presenting output from said server application and receiving runtime user input to said server application;
providing a second display region having a defined location, in which graphical user interfaces are presented; and
in response to user interaction with said first graphical user interface,
selecting a first user interface element from said first graphical user interface, said first user interface element presenting a type of output from said server application or receiving a type of input to said server application; and
configuring a client application to display a second graphical user interface in said second display region, such that said second graphical user interface comprises a second user interface element for presenting said type of output from said server application or receiving said type of input to said server application.

2. The method of claim 1, wherein each one of said first user interface element and said second user interface element both presents said type of output and receives said type of input.

3. The method of claim 1, wherein said second display region is a sidebar region.

4. The method of claim 3, wherein presentation of graphical user interfaces in said sidebar region is controlled by a sidebar application.

5. The method of claim 1, wherein said user interaction with said first graphical user interface comprises selection of said first user interface element, said selection effected by a user placing a pointer on said first user interface element.

6. The method of claim 1, wherein said user interaction with said first graphical user interface is effected by a user opening a menu associated with said first graphical user interface, and selecting a menu item from said menu for sending or exporting said first user interface element to said second display region.

7. The method of claim 1, wherein said user interaction with said first graphical user interface is effected by a user dragging-and-dropping said first user interface element into said second display region, or by said user dragging-and-dropping an existing user interface in said second display region onto said first user interface element.

8. The method of claim 1, comprising providing a user interface configuration application for configuring said client application.

9. The method of claim 8, wherein said configuring comprises creating a script file for configuring said client application, and causing said script file to be executed so as to display said second user interface in said second display region.

10. The method of claim 8, comprising communicating to at least one of said user interface configuration application and said client application descriptor data describing said type of output or said type of input.

11. The method of claim 10, wherein said descriptor data is communicated from said server application or a system server to said least one of said user interface configuration application and said client application.

12. The method of claim 10, wherein said communicating comprises communicating through inter-process communication (IPC).

13. The method of claim 12, wherein said inter-process communication is compliant with one or more of common object request broker architecture (CORBA), distributed computing environment (DCE), Java Remote Method Invocation (Java RMI), object linking and embedding (OLE), component object model (COM), distributed component object model (DCOM), Windows .Net framework, Internet Information Services (IIS), and Windows communication foundation (WCF) framework.

14. The method of claim 10, wherein said communicating comprises communicating of data compliant with one or more of a hyper text transfer protocol (HTTP), an extended mark-up language (XML), an XML schema definition (XSD), a web service definition language (WDSL), and a Java programming language.

15. The method of claim 1, wherein at least one of said type of input and said type of output comprises one or more of data types selected from numerical ranges, character strings, integer ranges, named item sets, Boolean sets, read-only data, and binary status indicators.

16. The method of claim 1, wherein at least one of said first and second user interface elements comprises one or more of buttons, boxes, bars, menus, data entry fields, lists, graphs, and tickers for presenting said type of output or receiving said type of input.

17. A computer comprising a display, a processor and a computer readable medium storing thereon computer executable code, said computer executable code when executed on said processor causing said processor to:
display in a first display region, a first graphical user interface for communication with a server application, and comprising a plurality of user interface elements for presenting output from said server application and receiving runtime user input to said server application;
provide a second display region having a pre-defined location, in which client application presenting graphical user interface are presented; and
in response to user interaction with said first graphical user interface,
select a first user interface element from said first graphical user interface, said first user interface element presenting a type of output from said server application or receiving a type of input to said server application; and
configure a client application to display a second graphical user interface in said second display region, such that said second graphical user interface comprises a second user interface element for presenting said type of output from said server application or receiving said type of input to said server application.

18. The computer of claim 17, wherein said second display region is a sidebar region.

19. The computer of claim 18, wherein presentation of graphical user interfaces in said sidebar region is controlled by a sidebar application.

20. A computer readable medium storing thereon computer executable code, said computer executable code when executed on a computer causing a processor of said computer to perform the method of claim 1.

21. A method of operating a computer, comprising:
in response to user interaction with a first graphical user interface for communication with a server application, said first graphical user interface displayed in a first display region and comprising a plurality of user interface elements for presenting output from said server application and receiving runtime user input to said server application, said user interaction causing a first user interface element being selected from said first graphical user interface, said first user interface element presenting a type of output from said server application or receiving a type of input to said server application,
displaying a second graphical user interface, in a second display region having a defined location, such that said second graphical user interface comprises a second user interface element for presenting said type of output from said server application or receiving said type of input to said server application.

22. A computer comprising a display, a processor and a computer readable medium storing thereon computer executable code, said computer executable code when executed on said processor causing said processor to perform the method of claim 21.

23. A computer readable medium storing thereon computer executable code, said computer executable code when executed on a computer causing a processor of said computer to perform the method of claim 21.
